(19) United States
(12) Patent Application Publication
(10) Pub. No.: US 2006/0280547 A1
(43) Pub. Date: Dec. 14, 2006

(54) Pocket wash cloth

(76) Inventor: Yvonne Wyatt, Christiansburg, VA (US)

Correspondence Address: STEVENS DAVIS MILLER & MOSHER, LLP, 1615 L STREET, NW, SUITE 850, WASHINGTON, DC, 20036, US

(21) Appl. No.: 11/148,180

(22) Filed: Jun. 9, 2005

(51) Int. Cl. B43K 5/00; B43M 11/06

(52) U.S. Cl. 401/201; 401/196

(57) ABSTRACT

A wash cloth including a first layer of fabric and a second layer of fabric, the first layer overlapping the second layer such that a first edge of the first layer is substantially flush with a second edge of the second layer. The first layer of fabric is joined to the second layer of fabric along an attachment line extending from a first of two spaced points of contact at or adjacent the first edge and the second edge to the second point of contact to define a generally U-shaped pocket having opposed open and closed ends. The U-shaped pocket is of a sufficient size to hold a solid piece of soap. The open end is at or adjacent the first and second edges. The closed end is spaced from the first and second edges.

### FIELD OF THE INVENTION

This invention relates to bath accessories, specifically an apparatus which can assist in bathing, especially children and others who require assistance, as well as for providing for a use for otherwise small pieces of soap which may be difficult to handle and use.

### BACKGROUND OF THE INVENTION

Toilet soap in bar form is by far the most common type of soap employed in households, hotels, motels, etc. The use of soap in this form has certain longstanding disadvantages. It is not possible for a bar of soap to be completely consumed because it eventually becomes so small as to be ineffectual for further use in the normal way. The majority of persons discard the bar when it becomes this small.

Another characteristic of bar soap is its tendency to soften when kept in conventional soap trays or the like between periods of use. This softening reduces a bar of soap to a mushy consistency on its underside even when it is supported in such a way as to permit the drainage of moisture from the bar and the circulation of air therearound.

Another problem with bar soap is the slippery surface when wet which makes the bar difficult to hold. As a result, wet soap is often dropped. Sometimes the bar, when dropped, will break or split into two or more pieces. When a person is handicapped in a way to make it difficult for him to retrieve a dropped bar of soap, the dropping becomes a serious problem instead of a mere annoyance. In some cases where a person is seriously afflicted with arthritis in his hands, it is difficult to grip a bar of soap even before it becomes slippery, and virtually impossible to hold onto the bar after it gets wet. A blind person dropping a bar of soap in a shower will obviously have a greater problem than a person with good eyesight.

One attempt to overcome the above disadvantages was to mold a bar or ball of soap on a loop of synthetic material, “soap on a rope,” which would be resistant to the moisture present when the soap was not being used. The loop could be placed on a handle of the shower or tub fixture and used with a wash cloth in a conventional manner. When the ball or bar became too small for further use, the remaining soap and loop were discarded.

A means for overcoming the foregoing disadvantages can be seen in U.S. Pat. No. 4,480,939 (herein incorporated by reference in its entirety). Therein is disclosed a sack formed from synthetic netting material of a size to receive the common size of bar soap. The sack is not closed at its open end by reason of two upwardly extending flaps with means at their terminus to receive a hook element which extends outwardly from a base attached to a support surface. The texture of the netting permits easy holding of the soap even when wet. The texture of the netting is no more abrasive than the texture of a wash cloth with which use can be dispensed. A sighted person can easily place the sack on the hook. The sight impaired person can do so only by feeling for the hook in the course of which seeking the sack may be dropped. If the sack is dropped, the soap bar may slide out of the sack and this problem is compounded.

Additionally, washcloths have been available which conventional consist of a single sheet of fabric designed to be used together with a bar of soap in order to enable an individual to apply soap to the fabric for later application of the soap to the individual's body. Unfortunately, a number of individuals are disabled and are not able to utilize a bar of soap together with a washcloth in order to permit the washing of the individual's body.

U.S. Pat. No. 5,326,610 (herein incorporated by reference in its entirety) discloses a washcloth which includes a pocket for inserting a bar of soap therebetween. However, it employs an additional sewn flap to prevent the bar from being dislodged during normal use.

### SUMMARY OF THE INVENTION

It is a preferred object of the present invention to provide a pocket which is an integral portion of a washcloth for retaining an object, e.g. a bar of soap, therein. A mechanism of opposed fasteners is provided adjacent to the pocket to retain the object positioned within the pocket.

Another preferred object of the present invention is to provide a washcloth which permits a disabled individual or an individual with arthritic conditions to easily use the soap contained with the pocket affixed to the washcloth during normal washing.

These and other objects of the present invention are achieved by providing a washcloth including a pocket for holding an object therein.

The wash cloth includes a first layer of fabric and a second layer of fabric, the first layer overlapping the second layer such that a first edge of the first layer is substantially flush with a second edge of the second layer, the first layer of fabric joined to the second layer of fabric at least at two spaced points of contact at or adjacent the first edge and the second edge and along an attachment line extending from the first point of contact to the second point of contact to define a generally U-shaped pocket, wherein the U-shaped pocket has an open end and a closed end, the open end of the U-shaped pocket being opposed to the closed end of the U-shaped pocket, The U-shaped pocket being of a sufficient size to hold a solid piece of soap, the open end being at or adjacent the first and second edges, the closed end being a distance from the first and second closed ends. The U-shaped pocket open end defining a mouth having first and second opposed sides wherein the first opposed side is on the first layer of fabric and the second opposed side is on the second layer of fabric. A first fastener is positioned within the pocket on the first opposed side at or adjacent the mouth. A second fastener positioned within the pocket on the second opposed side at or adjacent the mouth and located to mate with the first fastener to releasably close the mouth. Typically the fabric is a cloth, most typically terrycloth.

In a first embodiment the washcloth comprises a first layer of fabric having a predetermined length and width and a second layer of fabric provided with a predetermined length and width. The second layer of fabric is secured to the first piece of fabric such that a first edge of the first layer of fabric is substantially flush with a second edge of the second layer of fabric and defines a pocket having an open end at or adjacent the first and second edges. The pocket opening is provided so that a person using the wash cloth may insert an object, for example a piece, or pieces, of soap, into the pocket. The pocket opening is also provided with opposed portions of fastener which mate to releasably close the mouth to retain the object in the pocket.

In one embodiment, the invention provides a terrycloth, or other suitable fabric, washcloth with a pocket in which to place a bar of soap which includes a first sheet of terrycloth and a second sheet of terrycloth of equal size to the first sheet. The first sheet is attached, typically by sewing, to the second sheet such that an edge of the first sheet overlaps an edge of the second sheet. The overlapped edges form a mouth for the pocket which opens and closes. Opposed inside walls of the pocket at or adjacent the mouth are provided with mating portions of a hook and loop fastener (VELCRO-type fastener) or other suitable fastener to control the opening and closing of the mouth of the pocket. The hook and loop fastener may be adjacent to the overlapped edges or may be adjacent the overlapped edges, for example, recessed about an inch to about half an inch to make it easier to open and close the mouth. a region at or adjacent the perimeter of the first and second sheets may also be attached by stitching, except of course for the portion defining the mouth of the pocket.

In another embodiment, the invention provides a terrycloth, or other suitable fabric, washcloth with a pocket in which to place a bar of soap wherein a single sheet of terrycloth. The single sheet is folded over to form two overlapping layers of terrycloth of equal or approximately equal size and such that an edge of the first sheet overlaps an edge of the second sheet. The two layers are attached by stitching, or other suitable linear attaching means, to define a pocket. The overlapped edges form a mouth for the pocket which opens and closes. Opposed inside walls of the pocket at or adjacent the mouth are provided with mating portions of a hook and loop fastener (VELCRO-type fastener) or other suitable fastener to control the opening and closing of the mouth of the pocket. The hook and loop fastener may be adjacent to the overlapped edges or may be adjacent the overlapped edges, for example, recessed about an inch to about half an inch to make it easier to open and close the mouth. A region at or adjacent the perimeter of the first and second sheets may also be attached by stitching, except of course for the portion defining the mouth of the pocket.

In another embodiment, the invention provides a terrycloth washcloth with a pocket in which to place a bar of soap. In particular, the washcloth includes a first sheet of terrycloth and a second (smaller) sheet of terrycloth attached, typically by sewing, to the first sheet such that an edge of the first sheet overlaps an edge of the second sheet. The overlapped edges form a mouth for the pocket which opens and closes. Opposed inside walls of the pocket at or adjacent the mouth are provided with mating portions of a hook and loop fastener (VELCRO-type fastener) or other suitable fastener to control the opening and closing of the mouth of the pocket. The hook and loop fastener may be adjacent to the overlapped edges or may be adjacent the overlapped edges, for example, recessed about an inch to about half an inch to make it easier to open and close the mouth.

The layers of fabric are typically rectangular, but other suitable shapes may be employed. For example, another embodiment could employ two individual circular layers of fabric sewn together to define a pocket. This embodiment would also have opposed inside walls of the pocket at or adjacent the mouth provided with mating portions of a hook and loop fastener (VELCRO-type fastener) or other suitable fastener to control the opening and closing of the mouth of the pocket.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The embodiments, features and advantages of the invention described herein will occur to those skilled in the art from the following description of a preferred embodiment and the accompanying drawing, in which:

FIG. 1 shows a front view of a first embodiment of the invention.

FIG. 2 shows a top view of the first embodiment of the invention along view II-II.

FIG. 3 shows a front view of second embodiment of the invention.

FIG. 4 shows a front view of third embodiment of the invention having a second layer of fabric smaller than its first layer of fabric employing circular layers of fabric.

FIG. 5 shows a front view of fourth embodiment of the invention.

FIG. 6 shows a front view of fifth embodiment of the invention.

FIG. 7 shows a front view of sixth embodiment of the invention.

### DETAILED DESCRIPTION OF THE INVENTION

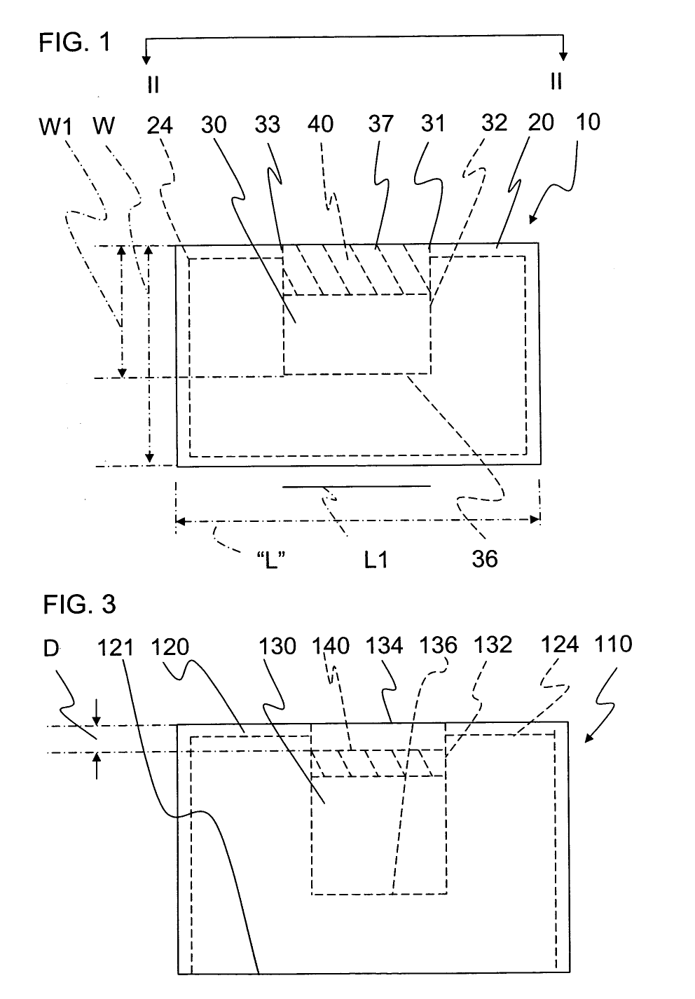

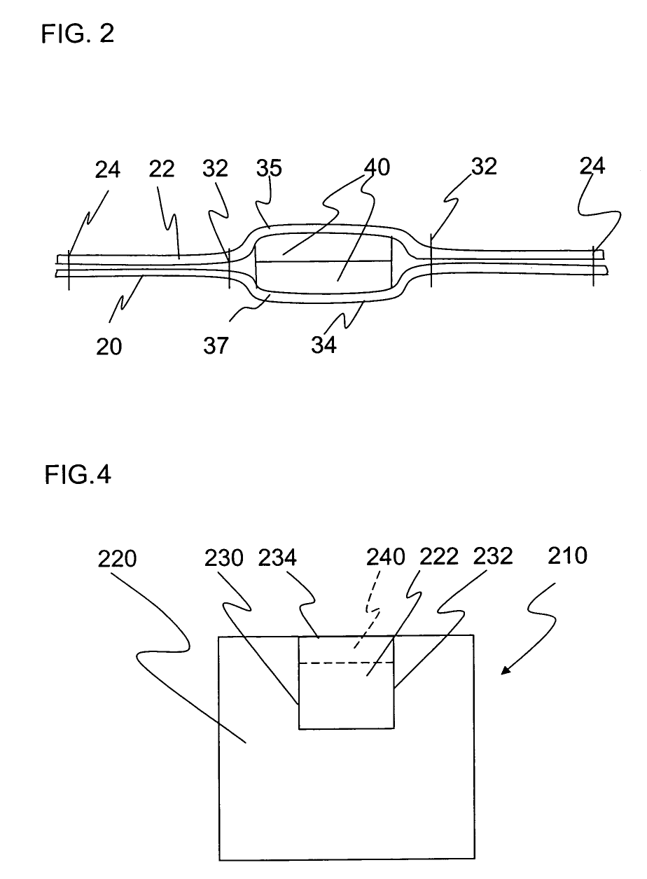

FIGS. 1 and 2 show a first embodiment of the invention having two individual (separate) sheets 20, 22 of terrycloth washcloth (sheet 20 shown in FIG. 1, sheets 20, 22 shown in top view FIG. 2). The two sheets 20, 22 are attached by stitching 32 (shown as dashed lines in FIG. 1 and schematically shown in FIG. 2) starting and ending from contact points 31, 33 at the ends of the opposed sides of the mouth 24 to form a pocket 30 in which to place a bar of soap. The mouth 34 for the pocket 30 opens and closes.

The sheets 20, 22 are also stitched together by stitching 24 about the perimeters of the overlapped sheets except for a mouth 34 (FIG. 2) on a portion of one side of the perimeter. In the embodiment of FIG. 1, the pieces of cloth 20, 22 are equal or approximately equal in size. However, the sheets may be of unequal size if desired.

Although the present embodiments may be described as being made of terrycloth, it is within the scope of the invention to vary the material being used, for example to any suitable fabric. Terrycloth is a typical uncut pile weave fabric formed by using two sets of warp yarns, wherein one set of warp yarns is under very little tension; when the filling yarns are packed into place, these loose yarns are pushed backward along with the filling yarns, and loops are formed.

Two mating pieces of a hook and loop fastener 40 (VELCRO-type fastener) are provided at the mouth 34 of the pocket 30 to releasably close the mouth thereby controlling the opening and closing of the mouth 34 of the pocket 30. The hook and loop fastener 40 may be adjacent to the overlapped edges 35, 37 as shown in FIG. 1 or, as shown in a second embodiment of FIG. 3, the hook and loop fastener 140 may be recessed a distance D, for example about an inch to about half an inch, from the open edges of the mouth 134 to make it easier to open and close the mouth 134.

Each piece of the hook and loop fastener 40 may be attached to each respective sheet 20, 22 of terrycloth by its own stitching (not shown). The pocket 30 does not extend all the way down the sheets 20, 22. Thus, as shown in FIG. 1, the closed end 36 of the pocket 30 is spaced from all sides of the perimeter of the sheets 20, 22.

Although hook and loop fastener is discussed above, any suitable mating fastener may be employed to releasably close the mouth. For example, mating male and female portions, such as those used for a ZIP-LOC brand storage bag, are suitable. Moreover, although stitching is discussed above, any suitable linear fastener, capable of attaching the layers of fabric along a line may be employed, for example, hot melt glue or welding if the fabric is thermoplastic polymer.

Moreover, FIG. 1 shows the stitching as continuous from a starting point to an ending point. However, the stitching may be discontinuous, i.e., there are breaks along its path, so long as sufficient stitching is present for it to achieve its purpose. For example, the embodiment of FIG. 3, discussed in more detail below, does not have stitching along a bottom portion of its perimeter. Such stitching along the bottom portion on this perimeter is optional, especially since this embodiment employs a single sheet of fabric folded over to form two layers of fabric.

The present invention may be made from two separate pieces of cloth which are attached, as discussed above, or made from a single piece of cloth. Typically the wash cloth pocket 30 has dimensions such that the first point of contact 31 is a distance “L1” of 1 to 5 inches from the second point of contact 33, more typically the first point of contact 31 is 2 to 4 inches from the second point of contact 33. Also, typically the opposed open and closed ends of the U-shaped pocket are a distance “W1” of 4 to 6 inches apart. Also, typically the first layer 20 is rectangular and has a length “L” of 8 to 14 inches and a width “W” of 8 to 14 inches, more typically a length “L” of 10 to 14 inches and a width “W” of 10 to 14 inches. Typical dimensions are “W” of about 12 inches and “L” of about 12 inches.

FIG. 3 shows an embodiment 110 made from a single piece of cloth 120. The single piece of cloth 120 is folded once along a fold line 121 to result in one layer of cloth overlapping another layer of cloth of substantially equal size (one layer shown in FIG. 3) and such that, as in the first embodiment, a first edge of the first layer of cloth overlaps (is flush) with a second edge of the second layer of cloth. Stitching 132, or another linear means of attachment, is provided to define a generally U-shaped pocket 130. Stitching 124, or other linear means of attachment, is also provided along or adjacent the perimeter of each layer of cloth to attach the first layer of cloth to the second layer of cloth. The pocket 130 does not extend all the way down the layers (layer 120 shown). Thus, as shown in FIG. 3, the closed end 136 of the pocket 130 is spaced from all sides of the perimeter of the layers. The embodiment of FIG. 3 is also provided with mating fastener portions 140 (one shown) to releasably close the mouth 134 of the pocket 130. However, FIG. 3 shows the fasteners 140 are recessed a distance “D” from the edge of the mouth 134. Distance “D” typically ranges from about 0.5 to about 1 inch.

FIG. 4 shows a third embodiment of a wash cloth 210 made from two pieces of cloth 220, 222, aligned to have one overlapping edge. The second piece of cloth is smaller than the first piece of cloth 220. The first piece of cloth 220 is attached to the second piece of cloth 222 by stitching 232, or other linear attaching means such as hot melt glue or welding. The stitching 232 is placed at or adjacent the perimeter of the smaller piece of cloth 222, which overlaps the larger piece of cloth 220 except for the portion defining the mouth 234. This wash cloth 210 is also provided with opposed hook and loop fasteners 240, or other suitable mating fasteners, to releasably close its mouth 234 to retain objects (not shown) in its pocket 230.

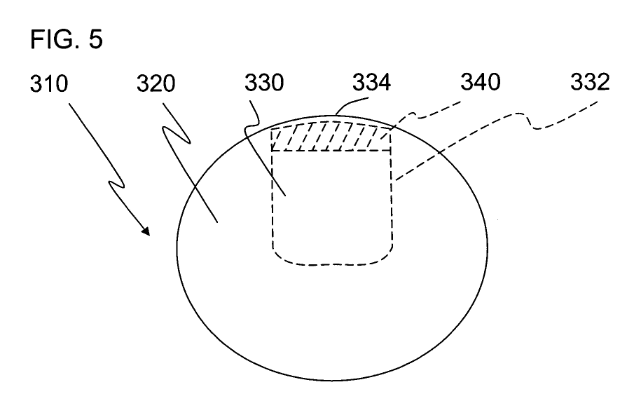

FIG. 5 shows a fourth embodiment of a wash cloth 310 of the present invention also made of two overlapping individual pieces of cloth of equal or approximately equal size and provided with stitching 332, or other appropriate linear fastening means, to define a pocket 330 having a mouth. This wash cloth 310 is also provided with opposed hook and loop fasteners 240, or other suitable mating fasteners, to releasably close its mouth 334 to retain objects (not shown) in its pocket 330. Stitching (not shown), or other suitable linear attaching means, may be provided at or adjacent a perimeter defined by the portions of the two pieces of cloth which overlap, except of course for the open portion of perimeter defining the mouth of the pocket 330.

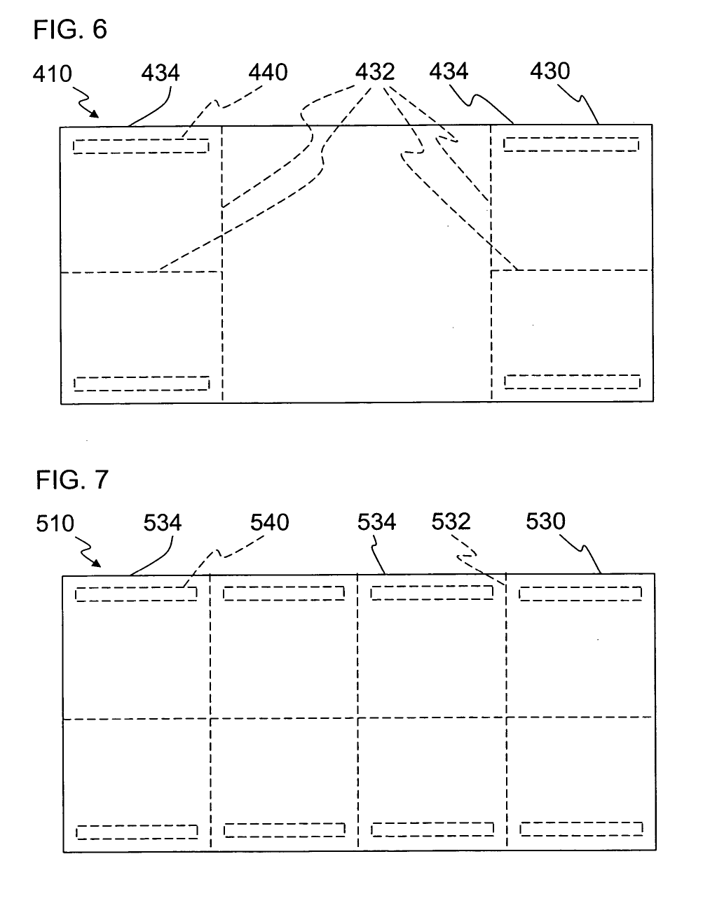

FIG. 6 shows a sixth embodiment of a wash cloth 410 of the present invention also made of two overlapping individual pieces of cloth of equal or approximately equal size and provided with stitching 432, or other appropriate linear fastening means, to define four pockets 430 each respectively having a mouth 434. This wash cloth 410 is also provided with opposed hook and loop fasteners 440, or other suitable mating fasteners, to releasably close its mouth 434 to retain objects (for example, pieces of soap, not shown) in its pockets 430. Stitching (not shown), or other suitable linear attaching means, may be provided at or adjacent a perimeter defined by the portions of the two pieces of cloth which overlap, except of course for the open portions of perimeter defining the mouths of the respective pockets 430.

FIG. 7 shows a seventh embodiment of a wash cloth 510 of the present invention also made of two overlapping individual pieces of cloth of equal or approximately equal size and provided with stitching 532, or other appropriate linear fastening means, to define eight pockets 530 each respectively having a mouth 534. This wash cloth 510 is also provided with opposed hook and loop fasteners 540, or other suitable mating fasteners, to releasably close its mouth 534 to retain objects (for example, pieces of soap, not shown) in its pockets 530. Stitching (not shown), or other suitable linear attaching means, may be provided at or adjacent a perimeter defined by the portions of the two pieces of cloth which overlap, except of course for the open portions of perimeter defining the mouths of the respective pockets 530.

It should be apparent that embodiments other than those expressly disclosed above come within the spirit and scope of the present claims. Thus, the present invention is not limited by the above-provided description, but rather is defined by the claims appended hereto.

I/We claim:

1. A wash cloth having a pocket of a sufficient size to hold at least one solid piece of soap comprising:
a first layer of fabric and a second layer of fabric,
the first layer overlapping the second layer such that a first edge of the first layer is substantially flush with a second edge of the second layer, the first layer of fabric joined to the second layer of fabric at least at two spaced points of contact at or adjacent the first edge and the second edge and along an attachment line extending from the first point of contact to the second point of contact to define a generally U-shaped pocket,
wherein the U-shaped pocket has an open end and a closed end,
the open end of the U-shaped pocket being opposed to the closed end of the U-shaped pocket,
the open end being at or adjacent the first and second edges,
the closed end being a distance from the first and second edges,
the U-shaped pocket open end defining a mouth having first and second opposed sides wherein the first opposed side is provided by the first layer of fabric and the second opposed side is provided by the second layer of fabric,
a first fastener positioned within the pocket on the first opposed side at or adjacent the mouth;
a second fastener positioned within the pocket on the second opposed side at or adjacent the mouth and located to mate with the first fastener to releasably close the mouth.

2. The wash cloth of claim 1, wherein the attachment line defining the pocket is continuous.

3. The wash cloth of claim 1, wherein the two layers of fabric are of equal or substantially equal size and joined along a continuous or discontinuous path extending outwardly, relative to the pocket, from the first point of contact to the second point of contact along an annular region at or adjacent the perimeter of the first and second layers of fabric.

4. The wash cloth of claim 1, wherein the two layers are individual pieces of fabric.

5. The wash cloth of claim 1, wherein the two layers of fabric are a single sheet of fabric having a first portion of the sheet folded over a second portion of the sheet, the first portion of the sheet being the first layer of fabric and the second portion of the sheet being the second layer of fabric.

6. The wash cloth of claim 1, wherein the attachment line comprises two spaced substantially parallel attachment lines and a transverse attachment line,
a first of the two spaced substantially parallel attachment lines extending from the first point of contact at or adjacent the first and second edges,
a second of the two spaced substantially parallel attachment lines extending from the second point of contact at or adjacent the first and second edges,
the transverse attachment line spaced from the first and second edges and spaced from a perimeter of at least one of the first and second layers.

7. The wash cloth of claim 1, wherein the first and second layers of fabric are of the same size and shape and have a plurality of sides;
stitching, joining the first and second layers of fabric at or adjacent the respective perimeters of the layers except for the portion of the perimeter at which the mouth is located.

8. The wash cloth of claim 1, wherein the fastener is a hook-and-loop fastener and one component of the fastener is positioned on each of the first and second sheets.

9. The wash cloth of claim 1, further comprising stitching, displaced from the first and second edges, defining a pocket, having a plurality of sides.

10. The wash cloth of claim 1, wherein the first and second layers of fabric are rectangles.

11. The wash cloth of claim 1, wherein the first and second layers of fabric are terrycloth.

12. The wash cloth of claim 1, wherein the first layer of fabric is smaller than the second layer of fabric.

13. The wash cloth of claim 1, wherein the first point of contact is 1 to 5 inches from the second point of contact.

14. The wash cloth of claim 1, wherein the first point of contact is 2 to 4 inches from the second point of contact.

15. The wash cloth of claim 1, wherein the opposed open and closed ends of the U-shaped pocket are 4 to 6 inches apart.

16. The wash cloth of claim 1, wherein the first layer is rectangular and has a length of 8 to 14 inches and a width of 8 to 14 inches.

17. The wash cloth of claim 1, wherein the first layer is rectangular and has a length of 10 to 14 inches and a width of 10 to 14 inches.

18. The wash cloth of claim 1, wherein the fasteners are a distance of about 0.5 to about 1 inch from the first and second edges.

19. The wash cloth of claim 1, having more than one said U-shaped pocket,
wherein each U-shaped pocket has an open end and a closed end,
the open end of each U-shaped pocket being opposed to the closed end of the respective U-shaped pocket,
the open end of each U-shaped pocket being at or adjacent a respective portion of the perimeters of the first and second layer where the perimeters of the first and second layers overlap,
for each pocket the first layer of fabric is joined to the second layer of fabric at least at two spaced points of contact at or adjacent the respective overlapped portion of perimeters and along an attachment line extending from the first point of contact to the second point of contact to define the respective generally U-shaped pocket,
the closed end being a distance from the overlapped portions of the first and second perimeters,
each U-shaped pocket open end defining a respective mouth having first and second opposed sides, wherein the first opposed side is provided by the first layer of fabric and the second opposed side is provided by the second layer of fabric,
a respective first fastener positioned within the respective pocket on the first opposed side at or adjacent the mouth;
a respective second fastener positioned within the respective pocket on the second opposed side at or adjacent the mouth and located to mate with the first fastener to releasably close the mouth.
